(19) United States
(12) Patent Application Publication
(10) Pub. No.: US 2020/0201921 A1
(43) Pub. Date: Jun. 25, 2020

(54) SYSTEM AND METHOD FOR FACILITATING COMMUNICATION WITHIN A TIERED ENVIRONMENT

(71) Applicant: Chad Fuller, Scottsdale, AZ (US)

(72) Inventor: Chad Fuller, Scottsdale, AZ (US)

(21) Appl. No.: 16/722,908

(22) Filed: Dec. 20, 2019

Related U.S. Application Data
(60) Provisional application No. 62/784,146, filed on Dec. 21, 2018.

(51) Int. Cl. G06F 16/9535; G06F 16/9538; G06Q 30/06; G06Q 10/08

(52) U.S. Cl. CPC G06F 16/9535; G06F 16/9538; G06Q 30/0627; G06Q 30/0613; G06Q 10/0875; G06Q 30/0607

(57) ABSTRACT

The invention is directed to a system and method for facilitating communication within a tiered environment. The system preferably includes a database and a dissemination server. The database contains a plurality of item records, each describing a different beverage item provided by a distributor. The dissemination server is configured to receive and authenticate credentials from an individual, and provide a listing of available items. The server is configured to receive orders from a plurality of individuals, consolidate them, and generate an ordering summary to requisition items from a distributor. The ordering summary is sent to the distributor. Upon receipt of the requested items, the dissemination server notifies each of the plurality of individuals that the requested items are available for retrieval.

### RELATED APPLICATIONS

This application claims the benefit of U.S. provisional patent application 62/784,146, filed Dec. 21, 2018 titled “System And Method For Facilitating Consumer Purchase of Spirits From A Distributor,” the entirety of the disclosure of which is hereby incorporated by this reference.

### TECHNICAL FIELD

Aspects of this document relate generally to systems and methods for facilitating communication.

### BACKGROUND

In the United States, the sale of alcoholic beverages is controlled by the laws enacted by the individual states (and the smaller county and local jurisdictions within each state). These laws regulate who may produce liquor, who may buy liquor, who they may sell it to, when and where liquor may be served, the amount that can be served, how much it may be served for, and to whom it may be served. With the exception of Washington state, each state makes use of some form of a three-tier system in regulating the sale of alcoholic beverages.

In the wake of the repeal of Prohibition, the United States adopted a three-tier system for the careful regulation of alcohol sales. The first tier is the producers, the second tier is the distributors, and the third tier is the retailers (e.g. stores, restaurants, etc.). The producers are only able to sell to the distributors, who in turn are only able to sell to the retailers. Retailers are the only parties able to sell to consumers. The beverages take on a percentage markup at each tier, often the largest markup being passed on to the consumer. This is particularly true in the case of restaurants, where increased overhead and the ability to sell by the glass sometimes results in a markup of many times the original price paid to the producer.

Attempts have been made to establish direct-to-consumer sale of alcoholic beverages. Exceptions are sometimes made for wineries, enabling them to sell directly to consumers. However, doing so across state lines is quickly complicated (and sometimes prohibited) by the law.

### SUMMARY

According to one aspect, a system for facilitating communication within a tiered environment includes a database including a first plurality of item records, each item record describing a different beverage item provided by a distributor having a distributor liquor license within the tiered environment permitting the sale of alcohol to retailers. Each item record has at least an item name, an item number, an inventory amount, and a retail price. The database further includes a plurality of individual records, each associated with a different individual and including a contact information, as well as a plurality of retailer records each associated with a different retailer. The system also includes a dissemination server having a processor and a memory. The dissemination server is communicatively coupled through a network to the database, a distributor server associated with the distributor, and a plurality of client devices associated with a plurality of individuals personally unlicensed within the tiered environment. The plurality of client devices include a first client device associated with a first individual, and an agent client device associated with an agent of an entity who is a retailer within the tiered environment. The entity has a retailer liquor license permitting the sale of alcohol to individuals. The processor of the dissemination server is configured to receive from the first client device, over the network, credentials belonging to the first individual, for authentication, the credentials having been endorsed by the entity. The processor is also configured to authenticate, using the processor, the credentials of the first individual, and provide to the first client device a listing of beverage items generated using at least a subset of the first plurality of item records elected by the agent of the entity. The listing of beverage items includes, for each item elected by the agent, at least the item name and a consumer price generated by applying a markup to the retail price. The markup is stored in a retailer record specific to the entity, within the database. The processor is further configured to receive an order from the first client device requesting at least one beverage item, and consolidate, in response to a request from the agent client device, a plurality of orders received by the dissemination server from the plurality of client devices by determining a sum of requested item quantities for each beverage item requested in the plurality of orders. Each order requests at least one beverage item. The processor is configured to generate an ordering summary including, for each beverage item requested in the plurality of orders, the item number, the item name, the item description, the sum of requested item quantities, and the retail price. The processor is also configured to send the ordering summary to the distributor server over the network, on behalf of the entity and in response to an instruction received from the agent via the agent client device, as well as retrieve from the database, for each individual of the plurality of individuals, the contact information for the individual. Finally, the processor is configured to notify each individual of the plurality of individuals, using the contact information retrieved from the database, to pick up the at least one beverage item requested in their order, upon determination that the at least one beverage item has arrived from the distributor.

Particular embodiments may comprise one or more of the following features. The processor of the dissemination server may be further configured to update the inventory amount an/or the retail price of each item record of a second plurality of item records in the database. The second plurality of item records may be at least a subset of the first plurality of item records. The processor of the dissemination server may be configured to automatically update the inventory amount and/or the retail price of each item record of the second plurality of item records using information obtained by the dissemination server directly from the distributor server. The generation of the ordering summary may include the generation of a document for the agent to convey to the distributor. The generation and sending of the ordering summary may include the generation and transmission of an email from the dissemination server to the distributor. The processor of the dissemination server may be further configured to retrieve at least one branding media associated with the entity from the database. The listing of beverage items may be provided to the first client device concurrently with the at least one branding media associated with the entity. The listing of beverage items may be provided to the first client device through integration with a website managed by the entity. The listing of beverage items may be accessible to the first client device via the website served from an entity server communicatively coupled to the dissemination server through the network. The database may further include least one event record. Each event record may describe an event sponsored by at least one of the distributor and a producer having a producer liquor license within the tiered environment permitting the sale of alcohol to distributors. Each event record may include at least an event name, an event date, a number of remaining seats, and/or reference to at least one related beverage item records for at least one related beverage item available from the at least one of the distributor and the producer as part of the event. The processor of the dissemination server may be further configured to provide to the first client device a listing of events generated using at least a subset of the at least one event records, as elected by the agent of the entity. The listing of events may include, for each event elected by the agent, at least the event name, the event date, the number of remaining seats, and/or the item name of the at least one related beverage item. The processor of the dissemination server may further be configured to generate, for each individual of the plurality of individuals, a periodic summary identifying the beverage items received for the individual by the entity from the distributor within a fixed period of time, and/or at least a total amount due to the entity. The total amount due may include a sum of the consumer price of each beverage items received for the individual, as determined when the beverage item was requested by the individual. The determination that the at least one beverage item has arrived from the distributor may be made automatically by the dissemination server through communication with at least one of the distributor server and a third-party server.

According to another aspect of the disclosure, a method for facilitating communication within a tiered environment includes storing in a database communicatively coupled to a dissemination server a first plurality of item records, each item record describing a different beverage item provided by a distributor within the tiered environment. Each item record includes at least an item name, an item number, an inventory amount, and a retail price. The method also includes receiving at the dissemination server, over a network, credentials from a first individual for authentication, the first individual unlicensed within the tiered environment. The credentials were endorsed by an entity with whom the individual is affiliated. The entity is a retailer within the tiered environment and has a retailer liquor license permitting the sale of alcohol to individuals. The method includes authenticating, using a processor and a memory of the dissemination server, the credentials of the first individual, and providing to a first client device associated with the first individual a listing of beverage items generated using at least a subset of the first plurality of item records elected by an agent of the entity. The listing of beverage items includes, for each item elected by the agent, at least the item name and a consumer price generated by applying a markup to the retail price. The markup is stored in a retailer record specific to the entity, within the database. The method further includes receiving an order from the first individual requesting at least one beverage item, and consolidating, in response to a request from the agent of the entity, a plurality of orders from a plurality of authenticated individuals by determining a sum of requested item quantities for each beverage item requested in the plurality of orders. Each order requests at least one beverage item. The method includes generating an ordering summary including, for each beverage item requested in the plurality of orders, the item number, the item name, the item description, the sum of requested item quantities, and the retail price. The method also includes sending the ordering summary to the distributor, on behalf of the entity and in response to an instruction received from the agent, as well as retrieving, for each individual of the plurality of individuals, a contact information for the individual. The contact information is stored in an individual record in the database. Finally, the method includes notifying each individual of the plurality of individuals to pick up the at least one beverage item requested in their order, upon determination that the at least one beverage item has arrived from the distributor. The notification is performed using the contact information retrieved from the database.

Particular embodiments may comprise one or more of the following features. The method may further include updating the inventory amount and/or the retail price of each item record of a second plurality of item records in the database. The second plurality of item records may be at least a subset of the first plurality of item records. Updating the inventory amount and/or the retail price of each item record of the second plurality of item records may be done automatically, using information obtained by the dissemination server directly from a distributor server. The generation of the ordering summary may include the generation of a document for the agent to convey to the distributor. The generation and/or sending of the ordering summary may include the generation and/or transmission of an email from the dissemination server to the distributor. The method may include retrieving at least one branding media associated with the entity from the database. The listing of beverage items may be provided to the first client device along with the at least one branding media associated with the entity. The listing of beverage items may be provided to the first client device through integration with a website managed by the entity. The listing of beverage items may be accessible via the web site served from an entity server communicatively coupled to the dissemination server through the network. The method may further include storing in the database at least one event record. Each event record may describe an event sponsored by at least one of the distributor and a producer having a producer liquor license within the tiered environment permitting the sale of alcohol to distributors. Each event record may include at least an event name, an event date, a number of remaining seats, and/or reference to at least one related beverage item records for at least one related beverage item available from the at least one of the distributor and the producer as part of the event. The method may include providing to the first individual a listing of events generated using at least a subset of the at least one event records, as elected by the agent of the entity. The listing of events may include, for each event elected by the agent, at least the event name, the event date, the number of remaining seats, and/or the item name of the at least one related beverage item. The method may further include generating, for each individual of the plurality of individuals, a periodic summary identifying the beverage items received for the individual by the entity from the distributor within a fixed period of time, and/or at least a total amount due to the entity. The total amount due may include a sum of the consumer price of each beverage items received for the individual, as determined when the beverage item was requested by the individual. The determination that the at least one beverage item has arrived from the distributor may be made automatically by the dissemination server through communication with at least one of a distributor server and a third-party server.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1A is a network view of a system for facilitating communication within a tiered environment;

FIG. 1B is a schematic view of a tiered environment;

FIG. 2 is a schematic view of a database;

FIG. 3 is a schematic view of an ordering summary;

FIG. 4 is a schematic view of a periodic summary;

FIG. 5 is a system view of a method for facilitating communication within a tiered environment; and

FIG. 6 is a schematic diagram of a specific computing device that can be used to implement the methods and systems disclosed herein, according to one or more embodiments.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

In the United States, the sale of alcoholic beverages is controlled by the laws enacted by the individual states (and the smaller county and local jurisdictions within each state). These laws regulate who may produce liquor, who may buy liquor, who they may sell it to, when and where liquor may be served, the amount that can be served, and to whom it may be served. With the exception of Washington state, each state makes use of some form of a three-tier system in regulating the sale of alcoholic beverages.

Attempts have been made to establish direct-to-consumer sale of alcoholic beverages. Exceptions are sometimes made for wineries, enabling them to sell directly to consumers. However, doing so across state lines is quickly complicated (and sometimes prohibited) by the law.

Distributors are not able to directly market to individual consumers, because their license only permits them to sell to licensed retailers. Furthermore, operating a computer based system allowing license holders to sell to individuals would provide too much value to the distributor and violate state law. Traditionally, distributors and producers have been able to send representatives to promote a very limited selection of products, in person. For example, a representative may set up a tasting table at a country club, providing a number of wines for sampling. The representative is not able to take and fulfill orders made by people who enjoy the tasting and desire to own a case or two, as that would violate the law restricting them to selling only to parties in the next tier. Instead, the tasting table has a pile of paper forms. Interested buyers fill out a form with their information and desired order. At the end of the tasting, a food and beverage manager with the country club compiles all the orders from the paper forms and places an order with the distributor. When the order comes in, the manager must then distribute the items to the proper members. This approach requires hours of work for the manager and their staff. This conventional method has been used extensively, but is not scalable beyond a handful of items.

What is needed is a system that can allow consumers to participate at a retail-level within the tiered environment, expanding selection while reducing markup, without running afoul of the three-tier laws. Because of those laws, such a system cannot be reasonably provided by parties within the tiered environment.

Contemplated herein is a system and method for facilitating communication within a tiered regulatory environment, allowing individuals to participate at a retailer level. Rather than replacing the role of a retailer, the system contemplated herein stands outside of the three-tier system and acts as an intermediary, facilitating communication without ever receiving money or handling product. This allows the consumer purchase of packaged alcoholic beverages from a retailer such as a club, via a distributor.

For example, these systems and methods will facilitate the utilization of a private club's retail license, allowing member access to distributor inventory for home consumption. The system comprises a server that provides the club members with an organized catalog of the spirits available through the club's liquor license and distributor relationships. The server is configured to receive orders from club members, and facilitate their fulfillment by communicating with the club beverage manager. The system also streamlines the process in every way possible for the club beverage manager, who is ultimately responsible for making the purchases from the distributor and then delivering them to the club members, to comply with the three-tier system.

Advantageously, the contemplated systems and methods make use of the relationships already established between the retailer (e.g. club, etc.) and the distributor(s), as well as the personal customer service the club is already providing. This creates an additional stream of revenue for the club without requiring drastic changes, and also provides a sought-after convenience to the members.

Another advantages is that the overhead of implementing such a system is small for the club (e.g. no waitstaff needed, no glassware to wash, no occupation of limited seating, etc.), meaning the club can make a profit even with a reduced markup on the spirits. Passing some of these savings to the club members further incentivizes their participation. The members have a convenient way to purchase spirits at lower prices and receive them through their private club, and the club has a new stream of revenue without significant investment in new infrastructure or staff.

It should be noted that the system contemplated herein stands apart from the three-tier system in every way. All transactions where money is exchanged for alcohol take place outside the systems contemplated herein, and are only arranged by communicating through the system itself. No money or alcohol is handled by the operators of the system, only the passing of information. Furthermore, the systems and methods contemplated herein do not provide information to parties that would not otherwise be available, though much less conveniently. For example, agents of a retailer, such as the beverage manager of a private club, already have access to all of the information provided by the distributor, such as available products and their prices, and are already able to pass that information on to club members. The systems and methods contemplated herein are able to do this more efficiently than would ever be possible for an individual retailer. Additional benefits will be discussed, below.

Going forward, the terms spirits, alcohol, alcoholic beverages, wine, and liquor will be used interchangeably. In the context of the present description, these terms are making reference to beverages whose sale is regulated by law. Those skilled in the art will recognize that the systems and methods disclosed herein may be adapted for use in the sale of other regulated goods that may or may not exist within a three-tier system, such as tobacco products.

Furthermore, while many of the examples provided below are in the context of members of a private club purchasing alcohol through the club, from a distributor, those skilled in the art will recognize that the systems and methods contemplated herein may be adapted for use with any licensed retailer, including but not limited to public clubs, stores, restaurants, and other entities and organizations having a retail liquor license.

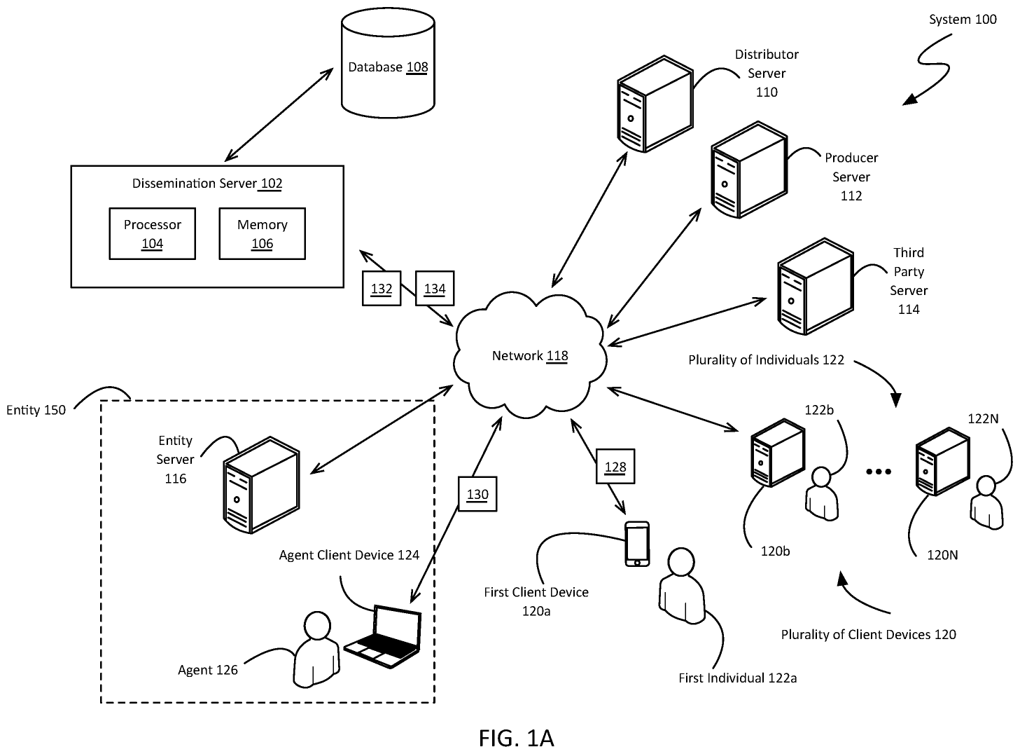

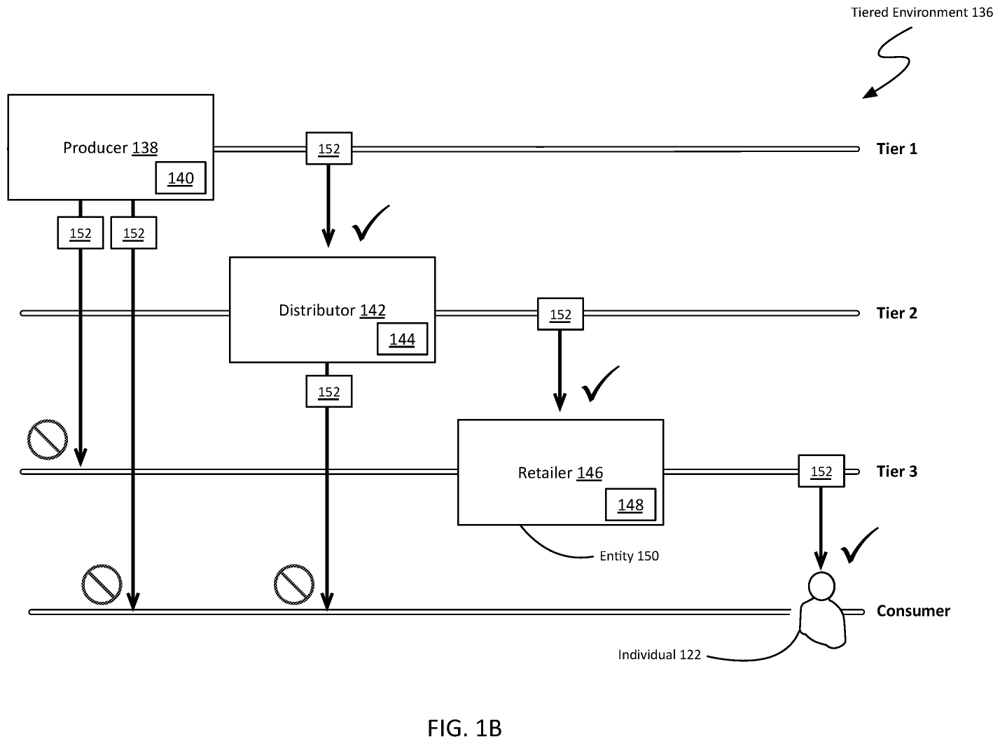

FIG. 1A is a network view of a non-limiting example of a system 100 for facilitating communication within a tiered environment. The system 100 and its components will be discussed in detail, below, but first they must be put into the context of a tiered environment. FIG. 1B is a schematic view of a non-limiting example of a tiered environment 136. Specifically, the tiered environment 136 shown is a three-tiered regulatory environment that is the basis for most liquor laws.

In the wake of the repeal of Prohibition, the United States adopted a three-tier system for the careful regulation of alcohol sales. The first tier is the producers 138, the second tier is the distributors 142, and the third tier is the retailers 146. The producers 138 of the first tier have a producer liquor license 140, which only allows them to sell alcoholic beverage items 152 to the distributors 142 of the second tier. Examples of producers 138 include, but are not limited to, wineries, distilleries, breweries, and the like.

The distributors 142 of the second tier have a distributor liquor license 144, which only permits them to sell alcoholic items 152 to the retailers 146 of the third tier. Retailers 146 have a retail liquor license 148 and are the only parties able to sell to individual consumers 122, who are unlicensed.

Retailer types are determined by the type of liquor license they purchased. For example, some have retail privilege (e.g. liquor stores, where buyers can take the liquor off site to consume elsewhere), some do not (e.g. restaurants who can serve liquor to patrons on site, but cannot sell liquor to be taken home), and some retailers have licenses allowing both (e.g. a license to primarily sell alcohol on site that also allows a specific portion of total revenue to be made with sales for off site use, etc.). It should be noted that, while many of the examples provided herein are in the context of a private club, these systems and methods may be adapted for use with a retailer 146 that is only licensed for off site consumption, such as a liquor store. The systems 100 contemplated herein could be used to give a liquor store thousands of additional items to offer customers without having to store them in inventory.

One example of a retailer type is a private club, such as a country club and the like. These clubs often have, as an amenity, a restaurant and/or a bar. Sometimes one of the touted perks of club membership is access to a selection of wine and other spirits otherwise difficult to obtain. In such an environment, the overhead of training and educating a staff to understand and properly sell these spirits reduces the profit margin, even with the customary high markup in a retail service environment.

Another example is a public golf course, or other public club having a liquor license. While many states have laws that require all licensed retailers to sell to anyone desiring to buy (i.e. retailers are not allowed to exclude any customers, even if part of an otherwise exclusive venue), the systems 100 contemplated herein represent an amenity, and may be made exclusive to club members having a member code.

Additionally, it should be noted that while various embodiments will be discussed in the context of interactions between a private club, a member of that club, and a distributor, other embodiments may be adapted to other types of tier-3 entities, such as stores, restaurants, and other retailers. The use of a private club should in no way be interpreted as limiting the scope of how and where the contemplated systems 100 and methods may be implemented.

Further discussion of the contemplated systems 100 will be done in the context of one or more individuals 122 purchasing alcohol 152 through an entity 150 with a retail liquor license 148 after selecting the alcohol 152 from the inventory of a distributor 142 with whom the entity 150 has a relationship. In some embodiments, the entity 150 may be a club, such as a private country club or a public golf club. In other embodiments, the entity 150 may be a store, like a liquor store or a bottle shop. In still other embodiments, the entity 150 may be a restaurant having an off site retail license. Those skilled in the art will recognize that the systems 100 and methods contemplated herein may be adapted for other properly licensed retail entities 150.

As shown in FIG. 1A, the system 100 comprises a dissemination server 102 having a processor 104 and a memory 106. According to various embodiments, the dissemination server 102 (hereinafter server 102) stands entirely removed from the tiered environment, meaning the operation of the server 102 to implement the methods contemplated herein does not require a liquor license of any type.

The server 102 is responsible for presenting individuals 122 with a catalog of available spirits, assisting an agent 114 of the entity 150 with making orders and getting them to the individuals 122. In some embodiments, the server 102 may also assist the agent 126 with ensuring the individuals 122 pay the entity 150. In some embodiments, the server 102 may even assist in determining an appropriate price for the spirits, while ensuring compliance with local law and/or three-tier system.

In some embodiments, the server 102 may be a discrete piece of hardware, while in others it may be a distributed computing environment spread across multiple machines. In some embodiments, the server 102 may be implemented in a cloud environment (e.g. the functionality described may be provided in an instantiated environment implemented on remote hardware, etc.).

As shown, the system 100 also includes a database 108. In some embodiments, the database 108 may be localized with (e.g. internal to, etc.) the server 102. In other embodiments, the database 108 may be distinct from the server 102. In still other embodiments, the database 108 may be remote to the server 102 and communicatively coupled through the network 118 (e.g. executed in a cloud environment, etc.). The database 108 may be implemented in any architecture known in the art, such as SQL, NoSQL, and the like.

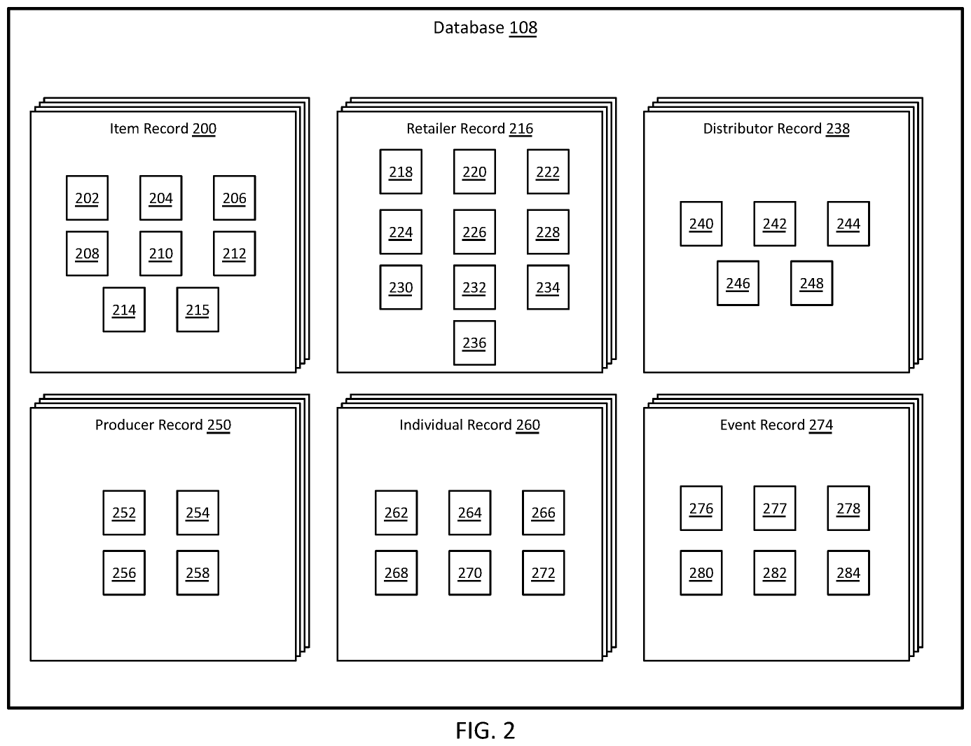

According to various embodiments, the database 108 may be used to store various information used by the system 100. Various records stored within the database 108 will be discussed in greater detail with respect to FIG. 2, below.

Throughout this disclosure, reference is made to representatives of a retailer, such as club beverage managers, and the like. These managers and representatives will be referred to as agents 114 or agents 114 of the entity 150. In the context of the present disclosure, a agent 114 is an individual or group of individuals who may legally interact with, order from, and take receipt from, a distributor 142. The requirements for agents 114 vary from jurisdiction to jurisdiction, but for the purposes of the present disclosure, it is someone who can order spirits from a tier-2 entity on behalf of a tier-3 entity, and is further authorized to distribute those spirits to consumers (i.e. individuals 122). It should be understood that portions of the activities and duties ascribed to the agent 114 in the disclosure below may be divided among multiple employees or representatives of the entity 150, depending on the laws. For example, the agent 114 may be responsible for getting the spirits to the individuals 122 who ordered them, but may be able to delegate that task to someone who is authorized to make such a delivery.

Furthermore, reference is made to individuals 122 (i.e. the first individual 122a, etc.). In the context of the present disclosure, an individual 122 is a consumer seeking to purchase spirits through the license of an entity 150. In some embodiments, it may be an entity 150 with which the individual 122 is associated (e.g. member of a country club, etc.). In embodiments where the tier-3 entity is not a club, an individual 122 may be thought of as a consumer interacting with the tier-3 entity to purchase from a tier-2 entity.

According to various embodiments, the dissemination server 102 provides one or more portals or channels through which individuals 122 and agents 126 may communicate via client devices (e.g. client devices 120, agent client device 124, etc.). In some embodiments, individuals 122 and/or agents 126 may interact with the server 102 through a custom application or app that runs on a client device 120 or agent client device 124. In other embodiments, the server 102 may provide a portal for individuals 122 and/or agents 126 that is accessible through a web browser.

According to various embodiments, the server 102 may serve a website over the network 118 that may be accessed from a client device 120. There may be three primary sections of the website, each of which has unique functions. Some or all of the sections may be password protected. Section 1 is for an individual 122 perform operations on behalf of themself, including but not limited to creating their profile, accessing an online shop through which they can place their orders, viewing their order history, and verifying orders. In some embodiments, an individual 122 will receive email confirmation, or confirmation via any channel known in the art, of their order 128 upon placement.

In some embodiments, section 1 may include a catalog of available alcoholic items 152. In other embodiments, the server 102 may provide a listing of beverage items 132 and/or listing of events 134 that is displayed to an individual 122 through incorporation into a website belonging to, and maintained, by the entity 150, allowing the entity 150 to provide the beneficial functionality provided by the system 100 without requiring individuals to leave the website served by the entity 150 (e.g. the country club website, a wine club website, etc.). As an option, in some embodiments, the listings provided, either served by the dissemination server 102 or displayed through a website belonging to the entity may be searchable and/or sortable, as is known in the art.

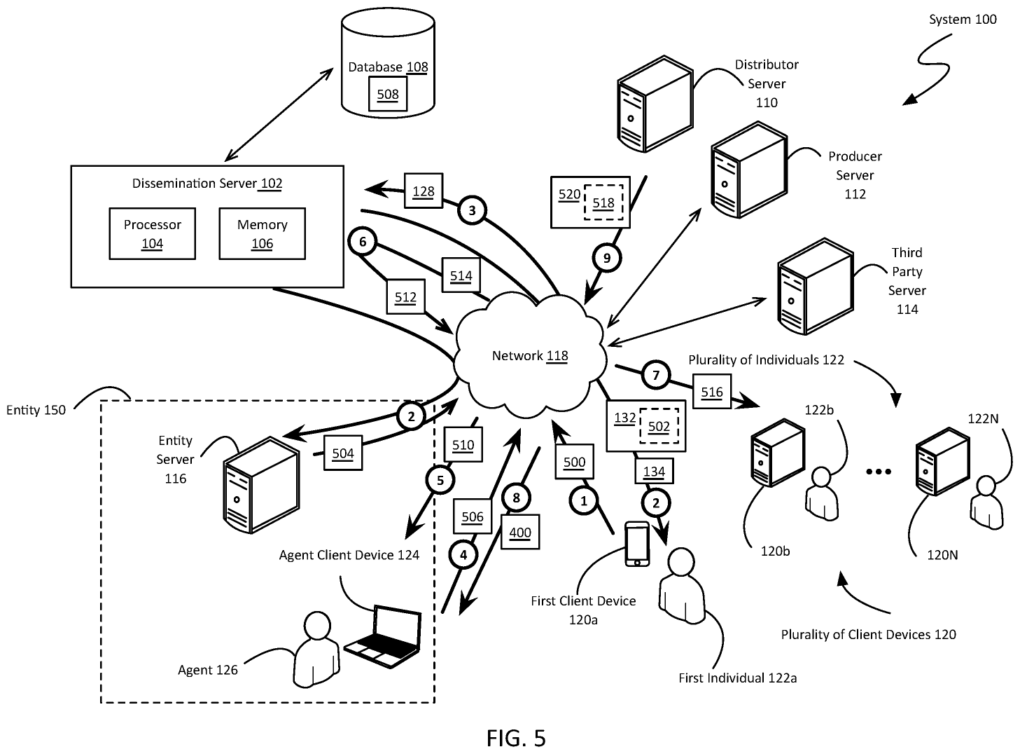

According to various embodiments, section 2 of the web site served by the server 102 is for agents 126. In some embodiments, it provides a workflow to assist the agent 126 in acknowledging orders, exporting copies of individual orders, viewing order history for individuals 122 or groups of individuals 122, viewing history of ordering summaries 130 (i.e. orders placed by the agent 126 with a distributor 142 on behalf of the entity 150), marking orders as read, setting a desired markup or margin for items sold through the entity 150, marking orders as received, shipments received from one or more distributors 142, and generating summaries of items purchased through the entity 150. In some embodiments, section 2 may provide an agent 126 with a drop down listing of all distributors 142 having a relationship with the entity 150, and may also display all of the items 152 available through those distributors 142. The workflow will be discussed further below, with respect to FIG. 5.

In some embodiments, section 3 is for website administrators. In some embodiments, section 3 may be used to assign specific products from the database 108 to individual retailers, manage new stores and store information, and manage oversight on pricing, margins, collective inventories, item accuracy, and overall site function.

It should be noted that while in some embodiments the server 102 may provide a website with all three sections, in other embodiments the website may be limited to two or even one section. For example, in some embodiments, the website may only have sections 2 and 3, while the listing of items available to an individual 122 may be incorporated into a website belonging to the entity 150 with whom the individual 122 is associated.

As shown, the server 102 is communicatively coupled to a plurality of client devices 120 and agent client devices 124. Individuals 122 and agents 126 interact with the server 102 through these devices. According to various embodiments, the client devices 120 and/or agent client device 124 may various computing devices, including but not limited to desktop computers, laptop computers, mobile devices such as smart phones and tablets, and the like. In some embodiments, the devices may interact with the server 102, or take part in the system 100 and/or methods contemplated herein, via a web portal, application, executable, or the like.

Those skilled in the art will recognize that other channels of interaction with the server 102 may be implemented. In some embodiments, some client devices 120 may be limited in what interactions are possible, due to their nature. For example, in some embodiments a member may resubmit a previous or nominal “favorite” order using a home assistant such as Amazon's Alex or Google's Home, but may be unable to examine the entire catalog available.

In some embodiments, the server 102 may be configured to interact with other servers. As shown, the dissemination server 102 may be communicatively coupled with one or more

distributor servers 110 through the network 118. In the context of the present description and the claims that follow, a distributor server 110 is a server that is associated with a distributor 142 in some way. For example, in some embodiments, the distributor server 110 may be a server owned, operated, and maintained by a particular distributor 142. In other embodiments, a distributor server 110 may be a server that simply hosts some form of information (e.g. database, website, etc.) related to and on behalf of a distributor 142.

In some embodiments, the server 102 may retrieve information from a distributor server 110 which may include, but is not limited to, information about specific alcoholic items 152 (e.g. descriptions, inventory, retail prices, promotional material, bottle photos, marketing material, videos, background information, reviews, etc.), as well as general information, such as a list of all items 152 available through that distributor 142.

The dissemination server 102 may also be communicatively coupled to one or more producer servers 112 through the network 118. In the context of the present description and the claims that follow, a producer server 112 is a server that is associated with a producer 138 in some way. For example, in some embodiments, the producer server 112 may be a server owned, operated, and maintained by a particular producer 183. In other embodiments, a producer server 112 may be a server that simply hosts some form of information (e.g. database, website, etc.) related to and on behalf of a producer 138.

In some embodiments, the server 102 may retrieve information from a producer server 112 which may include, but is not limited to, information about specific alcoholic items 152 (e.g. descriptions, promotional material, bottle photos, marketing material, videos, background information, reviews, etc.), as well as general information about the producer 138 that may be of interest to individuals 122, such as historical information about the producer 138.

As shown in FIG. 1A, in some embodiments the server 102 may also be communicatively coupled to an entity server 116, or in other words, a retailer server 116. In the context of the present description and the claims that follow, an entity server 116 is a server that is associated with the entity 150 in some way. For example, in some embodiments, the entity server 116 may be a server owned, operated, and maintained by a particular retailer 146. In other embodiments, the entity server 116 may be a server that simply hosts some form of information, related to and on behalf of the entity 150, such as a website. As mentioned, in some embodiments, the catalog or listing of beverages 132 may be provided to individuals 122 through a website belonging to the entity 150, allowing them to interact with the system 100 without leaving the entity's website. In such embodiments, the listing 132 may be sent to the entity server 116, after which it is incorporated with the entity's website. Other examples include, but are not limited to, entity servers 116 used to manage the operation of the entity 150 (e.g. membership database, amenity schedule, billing or invoice system used by entity 150, etc.).

In some embodiments, the dissemination server 102 may be communicatively coupled to one or more third-party servers 114 through the network 118. In the context of the present description and the claims that follow, a third-party server 114 is a server that is outside the tiered environment, and does not belong to or is operated by any of the parties within the tiered environment. Third-party servers 114 may store information that is pertinent to the implementation of the system 100. Exemplary third-party servers 114 include, but are not limited to, servers holding product information (e.g. reviews, articles, photographs, etc.), servers associated with the delivery of goods from a retailer (e.g. shipment tracking servers, etc.), and the like.

The non-limiting example of a system 100 shown in FIG. 1A only shows a single entity 150, or in other words, a single retailer 146. In some embodiments, a server 102 may provide the functionality and benefits disclosed herein to individuals 122 of a single entity 150 licensed as a retailer. However, in other embodiments, the dissemination server 102 may provide service to individuals 122 through a plurality of retailers/entities 150, and may also be communicatively coupled to a plurality of distributor, producer, entity, and third-party servers.

In some embodiments, the benefits of more than one retailer may be received by a single individual 122. As a specific example, a first individual 122a may have membership privileges with two clubs, each of which has a relationship with a different distributor 142. Both clubs may subscribe to a service provided by the contemplated system 100, implemented on a server 102 as software-as-a-service (SAAS) by another party. When that first individual 122a logs on to the server 102, the listing of spirits available to them may include spirits accessible through both clubs they hold membership with. As an option, the listing may filter to show the best price in cases where a spirit is available from multiple distributors, or priced with different markups, via different clubs. In other embodiments, system 100 may be implemented as SAAS, with each entity 150 being “siloed” and insulated from other retailers 146.

FIG. 2 is a schematic view of a non-limiting example of the database 108 of FIG. 1A. According to various embodiments, the database 108 may store a variety of record types including, but not limited to, item records 200, retailer/entity records 216, distributor records 238, producer records 250, individual records 260, event records 274, and the like.

In the following discussion, some record fields may be defined as describing one or more other records. In some embodiments, each record within the database 108 may have a unique index or identifier that may be used to point or link to that record from the field of another record, as is known in the art. The absence of said index/identifier in FIG. 2 should not be construed as limiting. In other embodiments, said referential fields may employ any other linking method known in the art of databases.

Furthermore, it should be noted that while a discrete set of records is shown in the non-limiting example of FIG. 2, and discussed below, those skilled in the art will recognize that the same information may be stored in a database 108 using more or less records. For example, the fields of a retailer record 216, as discussed below, could be broken up into multiple records in another embodiment (e.g. elected items 234 and elected events 236 may be stored in an election record that is separate from but pointed at by the retailer record 216, etc.). The following discussion of database records is meant to provide a context for discussing different pieces of information and media that may play a role in the systems 100 and methods contemplated herein, and should not be interpreted as the only way said information could be organized within the database 108. Additionally, in some embodiments, one or more types of records discussed below may be embedded within or encapsulated by another record type. For example, a collection of item records 200 could be incorporated as part of the distributor record 238 of the distributor offering said items 152, in one embodiment.

As shown, the database 108 may comprise a plurality of item records 200. According to various embodiments, an item record 200 comprises an item name 202, an item number 204 (e.g. SKU, UPC, GTIN, EAN, etc.), an item description 206 (e.g. volume, packaging, etc.), an inventory amount 208 (e.g. number of that item currently available from a source distributor, etc.), a retail price 210 (e.g. the price a retailer would pay for said item, etc.), a source distributor 212, a source producer 214, and promotional material 215 (e.g. tasting notes, photos, tech sheets, history, technical data, vintage information, reviews, etc.).

It should be noted that, in some embodiments, the system 100 may be used to facilitate communication regarding transactions that do not involve alcohol and therefore fall outside the tiered environment 136, along side the alcohol-based operations discussed throughout. As a specific example, in one embodiment, a country club may elect items to be offered to their members through their own website, using the system 100, that may include wines, spirits, as well as golf equipment, clothing, and even intangible items such as greens fees, lessons, and the like.

As shown, the database 108 may comprise a plurality of retailer records 216. According to various embodiments, a retailer record 216 comprises a unique retailer identifier 218 (e.g. an index assigned to that particular retailer, etc.), a name 220, an address 222, an agent 224 (e.g. the name and/or contact information for one or more agents 126 representing that retailer 146, a link to an individual or agent record associated with each agent 126 representing that retailer 146, etc.), a markup 226, branding media 228 (e.g. photos of the retailer's location, logos, trademarks, slogans, etc.), a license type 230 (e.g. on site, off site, etc.), affiliated distributors 232 (e.g. names of distributors 142 that retailer 146 has a relationship with, links to the distributor records 238 for said distributors 142, etc.), a list of elected items 234 (e.g. list of item numbers 204 or indices pointing to item records 200 for the items 152 provided by distributors that a retailer 146 has elected to offer for sale, etc.), and a list of elected events 236 (e.g. list of event numbers 277 or indices pointing to event records 274 for the distributor/producer events a retailer 146 has elected to offer for sale or reservation, etc.).

As mentioned, a retailer record 216 includes a markup 226, according to various embodiments. Under traditional operations within the three-tier system, beverages take on a percentage markup at each tier, often the largest markup being passed on to the consumer. This is particularly true in the case of restaurants, where increased overhead and the ability to sell by the glass sometimes results in a markup of many times the original price paid to the producer 138.

Using the systems 100 and methods contemplated herein, a retailer 146 is able to define a unique “shop” or listing of the items 152 available through their distributors 142 that they wish to offer to individuals 122 associated with the retailer 146 (e.g. members of a country club, account holders of a store's rewards program, members of a wine club, etc.). Each retailer 146 is able to define their own markup, which is stored in the markup 226 field of the retailer record 216. This means that different retailers 146 within the system 100 could offer the same item 152 from the same distributor 142 to individuals 122 at different consumer prices, because each retailer can set their own markup.

In some embodiments, the markup 226 may be a simple percentage that the retail price 210 of an item 152 is multiplied by to get a consumer price (e.g. the price shown to and paid by the individual 122, etc.). In other embodiments, the markup 226 may be defined in more sophisticated ways, said definition still being stored in a retailer record 216. In some embodiments, the margin may be defined as a static amount added to each transaction (e.g. per bottle, per transaction, etc.). In other embodiments, the margin may be defined using mathematical expressions that are more complicated than the multiplication of the retailer price by a set rate.

In some embodiments, a single margin may be defined for all items 152 available through that retailer 146. In other embodiments, multiple margins may be defined and stored in the retailer record 216. For example, margins may be defined for a subset of the elected items, a subset that may be defined by specific items (e.g. using item numbers or item record indices, etc.), item types (e.g. spirit type, etc.), source producer (e.g. can set a higher markup for items from one producer than items from another, etc.), and so forth. In some embodiments, the markup may differ on a different basis. For example, in one embodiment, the markup may be modified depending on the individual 122 viewing the listing (e.g. membership stratified by loyalty, membership length, dues paid, etc.). In another embodiment, the markup may be defined for different volumes, meaning a first markup may be used until a certain number of a particular item have been sold, and then a second markup may be applied to that item. Sometimes a distributor offers a certain per item price to a retailer, but if the retailer is not able to move a quota amount of the item, the price may increase. Being able to define a variable markup for particular items that changes based on the number of that item that have been sold is advantageous for a retailer as it allows them to reach the quota amount with greater certainty, avoiding potentially large expenses at the end of a fiscal period.

As mentioned, in some embodiments the retailer record 216 may indicate the type of liquor license held by the retailer 146. For example, in some jurisdictions, a license may be limited to particular types of beverages (e.g. particular alcohol content levels, etc.). In some embodiments, the specification of a license type 230 in the retailer record 216 may be used to filter the items 152 shown to an agent 126 of said retailer 146 when electing what should be offered to associated individuals 122. For example, a retailer only able to sell beer would not be shown the spirits offered by their distributors because they are not licensed to sell them.

As shown, in some embodiments, the retailer record 216 may include one or more pieces of branding media 228. According to various embodiments, the branding media 228 may be used to blur the lines between the system 100/server 102 and the retailer 146, from the point of view of individuals 122 associated with the retailer 146. In some embodiments, the individuals 122 may access the shop or be provided a listing of items through a website served by the dissemination server 102. In such embodiments, the website may change in appearance depending on which store/listing is being accessed, reminding the individual 122 who is making their access possible. In embodiments where the listing is provided to individuals through incorporation with the retailer's web site, the information provided to the entity server 116 may be modified to be consistent with the branding material. In both cases, the branding is accomplished by providing the listing/shop to the client device 120a concurrently with one or more pieces of branding media 228 associated with the entity 150.

As shown, the database 108 may comprise a plurality of distributor records 238. According to various embodiments, a distributor record 238 comprises a distributor name 240, contact information 242 (e.g. email address, fax, web portal, API, etc. for placing orders), an address 244, a list of item numbers 246 (e.g. a list of item numbers 204 or item record indices for items 152 offered by the distributor, etc.), and affiliated producers 248 (e.g. producers 138 having a relationship with the distributor, etc.).

The database 108 may also comprise a plurality of producer records 250. According to various embodiments, a producer record 250 comprises a producer name 252, an address 254, a list of items offered by the producer 256, and biographical data 258 (e.g. historical information about the producer, photos, awards, reviews, etc.).

As shown, the database 108 may comprise a plurality of individual records 260. According to various embodiments, an individual record 260 may comprise a unique individual identifier 262, a name 264, an address 266, an associated entity 268, an order history 270 (e.g. a full listing of past orders, links to past order records, etc.), and contact information 272. In the context of the present description and the claims that follow, contact information 272 within an individual record 260 is the information needed to notify the individual 122 that an order is ready for pickup or has arrived. Examples include, but are not limited to, an email address, a phone number, and the like.

In some embodiments, individual records 260 may be created as each individual 122 initiates contact with the server 102 for the first time. In other embodiments, a retailer 146 may provide a list of an entire group of individuals 122 to whom they are offering access (e.g. membership roster of a country club, participants in a loyalty program at a liquor store, etc.), and the entire group may be preloaded into the database 108.

As shown, the database 108 may comprise a plurality of event records 274. According to various embodiments, an event record 274 may comprise an event name 276, an event number 277 (e.g. a unique event index, etc.), an event date 278, an event type 280 (e.g. wine dinner, tasting, remote tasting, etc.), a number of remaining seats 282, and a list of related item records 284 (e.g. list of items 152 that will be involved in the event, etc.).

In the context of the present description and the claims that follow, and event is a non-tangible experience, presentation, or gathering with limited capacity for participating individuals. Reserving a seat or a unit of the limited capacity may be bought from a retailer 146, or it may be reserve at no cost. According to various embodiments, an event may be associated with one or more alcoholic beverage items 152 (e.g. wines offered at a wine dinner or tasted at a tasting or remote tasting, etc.). It should be noted that the system 100 may be used to help avoid overbooking limited capacity events that are not alcohol-related, according to some embodiments.

In some embodiments, the event record 274 may also include the identity of an involved party, such as a distributor 142 or a producer 138. One example of an event is a wine dinner. A vineyard hosts a dinner where, for a price, attendees get to taste and buy wine. Typically, wine dinners have very limited capacity. Traditionally, this meant that at a country club with hundreds of members, only 60 would have the chance to buy the wines tasted at the wine dinner. Those who could not attend were typically unable to purchase the wine. Advantageously, the system 100 not only prevents overbooking a wine dinner, by linking the associated items, every individual 122 associated with that retailer 146 will be able to purchase the beverages sampled at the dinner.

Another example of an event is a tasting. While the systems 100 and methods contemplated herein would solve problems of overbooking and lack of access to associated items 152 for those not in attendance, as they do for wine dinners as described above, a particular advantage is presented for tastings. According to various embodiments, the systems and methods contemplated herein facilitate communication and interaction between tier 1 and individuals in a way that previously was not practical. A virtual or remote tasting can be facilitated by a dissemination server 102 that can coordinate the use of limited capacity at multiple venues (e.g. retailers such as clubs and restaurants, etc.) as well as coordinate a live video stream, allowing participants at multiple locations to participate in a tasting with the producer 138, such as a wine maker. Individuals 122 associated with multiple entities 150 can taste the wines at their respective retailer locations, each of whom ordered a wine set from the producer before the event, while all listening to the winemaker walk them through the tasting, an experience (and purchasing opportunity) usually limited to the few individuals able to travel to the vineyard itself. The system 100 opens the lines of communication all the way down the three tier system without violating it.

In other embodiments of the system 100, additional information may be included in various records. Examples include, but are not limited to, information required for the legal sale of alcohol by the retailer, individual preferences, club memberships, notification preferences, price histories, and the like.

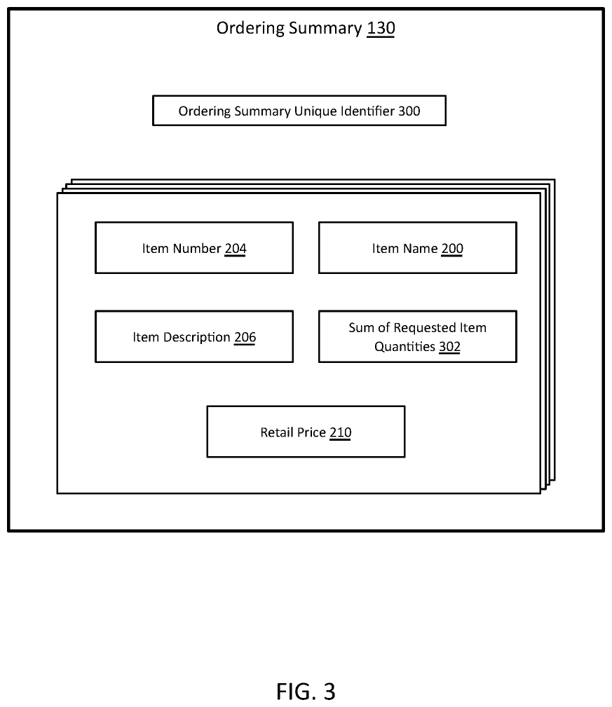

FIG. 3 is a schematic view of a non-limiting example of an ordering summary 130. In the context of the present description and the claims that follow, an ordering summary 130 is a summary of what needs to be purchased by the retailer from a particular distributor 142. It is the consolidation of one or more orders made by individuals, with respect to a single distributor 142. It is one of the many ways that the system 100 helps the agent 126 interact with a tier-2 party on behalf of a tier-3 party to implement the wishes of one or more individuals 122, according to various embodiments.

As shown, an ordering summary 130 comprises a unique identifier 300 that may be used to quickly refer to a particular purchase from a distributor 142. The ordering summary 130 further comprises, for each item 152 being requisitioned from the distributor 142, an item number 204, an item name 202, an item description 206, a sum of the requested item quantities 302 (e.g. the total number needed to fulfill orders from multiple individuals, etc.), and the retail price 210 (e.g. the price the retailer believes is being charged by the distributor, etc.). In FIG. 3, this collection of information for each item 152 ordered is represented as a plurality of records, each record associated with one item 152. The inclusion of information such as price and description may help ensure that there are no miscommunications, or if any occur, they can get remedied early in the process.

It should be noted that, while the non-limiting example of an ordering summary 130 shown in FIG. 3 is schematic in nature, showing the data as a collection of objects as would be fitting in a database context, in practice, the ordering summary 130 may exist in a number of different forms. In some embodiments, the dissemination server 102 generates an ordering summary 130 in the form of a document, such as a PDF, that is then provided to an agent 126. The agent 126 may then transmit the ordering summary 130 to the distributor 142 through any method preferred or required by either party (e.g. email attachment, fax, mail, hand delivered, etc.). The document itself may be formatted as a purchase order, according to some embodiments.

According to various embodiments, the document embodying the ordering summary 130 may have no indication that it was generated as part of the system 100. Indeed, according to some embodiments, the system 100 and methods contemplated herein may be implemented such that only the retailer 146 is aware that the system 100 is in use. From the point of view of the distributors 142 and producers 138, the retailer 146 appears to be operating in a manner typical of the tiered environment 136. It should be noted that this lack of indication is not an effort to hide activity that violates the tiered environment 136, but rather to ensure that retailers 146 making use of the system 100 are treated in a manner indistinguishable from how conventional retailers 146 are treated by the distributors.

In some embodiments, the dissemination server 102 may generate an ordering summary 130 in the form of an email that the agent 126 may then cause to be sent to the distributor 142 with a simple command, such that the three-tier system is not violated. As an option, the email may be formatted and addressed automatically per the requirements of that particular distributor 142.

In other embodiments, the dissemination server 102 may generate an ordering summary 130 in a different format that is compatible with a particular communication channel employed by the distributor 142. For example, in one embodiment, the distributor 142 may provide retailers 146 with an API through which orders may be placed (e.g. orders placed through the API may be automatically incorporated into a provisioning system used by the distributor, etc.). In such a case, the server 102 may format the ordering summary 130 such that it may be submitted via the API upon receipt of an instruction from the agent 126, such that the three-tier system is not violated. As a specific example, the ordering summary 130 may be generated and transmitted in formats including but not limited to JSON, XML, or any other data format known in the art.

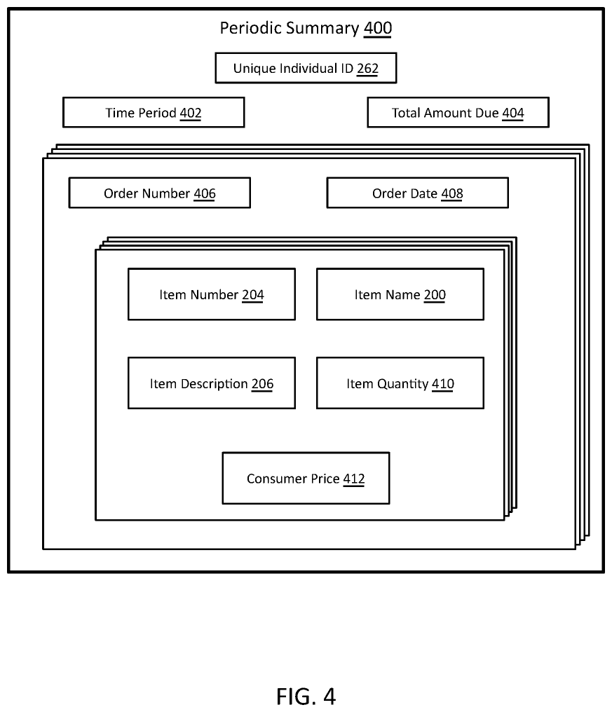

In some embodiments, the server 102 may be capable of generating the ordering summary 130 in multiple formats. For example, in one embodiment, the server 102 may generate an ordering summary 130 as a document that may be forwarded to the distributor 142, and also generated as a record in the database 108, for archival purposes and in preparation for later reports, such as the periodic summary 400 that will be discussed in the context of FIG. 4, below. The generation and transmission of ordering summaries 130 will be discussed further with respect to FIG. 5, below.

FIG. 4 is a schematic view of a non-limiting example of a periodic summary 400. In the context of the present description and the claims that follow, a periodic summary 400 is a collection of information that is provided to a retailer 146 describing the purchases that have been made at the request of a specific individual 122 over a certain period of time 402 (e.g. a month, etc.). Specifically, the periodic summary 400 identifies the beverage items 152 received for the individual 122 by the entity 150 from a distributor 142 within a fixed period of time, and includes at the least, a total amount due to the entity 150.

The periodic summary 400 allows the retailer 146 to then bill the individual 122 using whatever method that retailer 146 uses for other transactions with the individual 122. For example, a country club may attach the costs of transactions executed using communication through the dissemination server 102 to a monthly membership invoice common to country clubs, that includes all charges made on that individuals account. In contrast, a bottle shop, liquor store, or restaurant may use the periodic summary 400 to determine the total amount due before the individual 122 is able to pickup the items 152 they have ordered. As an option, in cases where the billing period is determined by a factor other than time (e.g. individual pays total due when picking up order, etc.), the periodic summary 400 may be generated on demand (e.g. in response to a command from an agent 126, in automatic response to a signal sent by the retailer's point of sale system, etc.), rather than at fixed intervals.

As shown, the periodic summary 400 identifies a particular individual 122 (e.g. by unique individual identifier 262, a link or pointer to an individual record 260, etc.), a fixed period of time 402, and a total amount due 404. According to various embodiments, the total amount due 404 is a sum of the consumer price 412 of each item 152 received for the individual 122 within the time period 402, as determined when the beverage item 152 was requested by the individual 122 (e.g. the individual is charged the consumer price 412 as calculated at the time the order was placed). The consumer price 412 is calculated by applying a markup 226 to the retail price 210, the markup 226 being retrieved from the retailer record 216 and the retail price being retrieved from the item record 200 appropriate for this specific item 152.

In some embodiments, the periodic summary 400 may solely be used to assist an agent 126 with invoicing the individuals 122 making use of the system 100. In such embodiments, the periodic summary 400 may be devoid of any additional information. In other embodiments, the periodic summary 400 may also be provided to the individual 122 to summarize and describe all the items 152 they purchase within that time period 402. As an option, in those embodiments (and in some others), additional information may be included in the periodic summary 400, making it useful to both the retailer 146 and the individual 122. For example, as shown, the periodic summary 400 may further comprise a collection of details for each order of a plurality of orders, the details comprising an order number 406 (e.g. a unique index, etc.) and the date the order was placed 408. The details for each order may also include a plurality of item details, one for each item purchased in that order. Said item details may include an item number 204, an item name 200, an item description 206, an item quantity 410 (e.g. how many were ordered/received), and the consumer price 412 for said item 152.

It should be noted that, while the non-limiting example of a periodic summary 400 shown in FIG. 4 is schematic in nature, showing the data as a collection of objects as would be fitting in a database context, in practice, the periodic summary 400 may exist in a number of different forms. In some embodiments, the dissemination server 102 generates a periodic summary 400 in the form of a document, such as a PDF, that is then provided to an agent 126 who may submit the document to whoever handles the billing (e.g. someone authorized to handle accounting and is not necessarily an agent within the tiered environment 136, etc.). The document itself may be formatted as an invoice, according to some embodiments.

In some embodiments, the dissemination server 102 may generate a periodic summary 400 in the form of an email that may be sent automatically to the party responsible for billing for the entity 150. Unlike the ordering summary 130, periodic summaries 400 may be sent to the retailer 146, or within the retailer's organization, automatically, as the three-tier system will not be violated by such an automation.

In other embodiments, the dissemination server 102 may generate a periodic summary 400 in a different format that is compatible with a particular system, device, or infrastructure employed by the retailer 146 for charging, invoicing, or billing. Examples include, but are not limited to, a format compatible with the API of a localized or cloud-based billing system. As a specific example, the periodic summary 400 may be generated and transmitted in formats including but not limited to JSON, WL, or any other data format known in the art.

In some embodiments, the server 102 may be capable of generating the periodic summary 400 in multiple formats. For example, in one embodiment, the server 102 may generate a periodic summary 400 as a document that may be forwarded to the individual 122, and also generated as a data object formatted for submission directly into an accounting and billing system used by the entity 150. The generation of periodic summaries 400 will be discussed further with respect to FIG. 5, below.

FIG. 5 is a system view of a non-limiting example of a method for facilitating communication within a tiered environment 136. According to various embodiments, access to the system 100 is limited to authorized individuals 122, though not out of necessity. Even in jurisdictions where liquor licenses prohibit the exclusion of anyone from purchasing alcohol (in compliance with other laws such as an age requirement, of course), the system 100 contemplated herein can be made private because it is simply the exchange of information outside of the three-tier system. Making the system 100 exclusive to authorized individuals 122 also emphasizes a feeling of exclusivity, something that plays a large role in the marketing of some retailers 146 such as private country clubs.

In embodiments where the system 100 is private, the dissemination server 102 first receives credentials 500 from a first client device 120a associated with a first individual 122a, for authentication by the server 102 (e.g. using the processor 104 of the server 102). See circle ‘1’. According to various embodiments, the credentials 500 and method of authentication may be any of those known in the art for secure communication over a network 118.

Next, the server 102 provides a listing 132 of beverage items available for purchase from the distributor 142, through the entity 150 (retailer 146) to the first client device 120a. See circle ‘2’. According to various embodiments, the listing 132 is generated using a subset 502 of a first plurality of item records 200 elected by an agent 126 of the entity 150. As discussed before, the listing 132 may comprise, for each item 152 elected by an agent 126, the item name 202 and a consumer price 412. In some embodiments, the server 102 may also provide a listing 134 of events, as well.

In some embodiments, the listing 132 (or catalog of spirits, or ‘store’) is provided to the first individual 122a through the first client device 120a by way of a website generated and sometimes even hosted by the dissemination server 102. In other embodiments, the listing 132 may be sent to the entity server 116, or referenced by code hosted on the entity server 116, and thus incorporated into a website 504 that is associated with the entity 150. As an option, in either case, the listing 132 may be accompanied by branding media for tighter integration with the entity 150, as discussed above. Furthermore, in some embodiments, the first individual 122a may be able to record their own notes about an item 152, which are stored as part of their profile on the server 102 and/or database 108.

Once the first individual 122a has selected one or more items 152 for purchase, they finalize the transaction. In some embodiments, additional steps may be performed during the finalization of the order 128, to satisfy the laws of the individual's 122a and/or entities 150 jurisdiction. The order 128 is received by the server 102. See circle ‘3’.

Once the first individual 122a has placed their order 128, the agent 126 of the entity 150 though which the order will be fulfilled is notified. This derailing of the computer-based workflow, placing the next step in the hands of a human representative, is important to staying within the confines of the three-tier system, and to further distinguish this system 100 from a direct-to-consumer distributor portal. As an example, in one embodiment, the agent 126 may receive an email detailing the order 128 that was made, while in another embodiment the order 128 may show up in a queue that is displayed to the agent 126 when they log into the server 102 through an agent client device 124.

In some embodiments, an agent 126 may also be able to place an order 128 on behalf of an individual 122. Traditionally, it is common for a member of a private club to place an order for a case of wine, for example, simply by asking a food and beverage manager in passing. The contemplated system 100 allows an agent 126 to place such an order 128 on behalf of an individual 122, ensuring that it is incorporated into the workflow like orders that are placed through the server 102 by the individuals 122. This allows individuals 122 to benefit from the convenience of this novel system 100 without disrupting traditional ways of performing this task.

In response to a request 506 received by the server 102 from an agent 126 through an agent client device 124, a plurality of orders 508 received by the server 102 (and, in some embodiments, subsequently stored in the database 108) from a plurality of client devices 120 is consolidated by the server 102. See circle ‘4’.

As discussed above, this consolidation of orders is performed, in part, by determining a sum of requested item quantities 302 for each item 152 requested in the plurality of orders 508. The consolidation results in the generation of an ordering summary 130.

As discussed previously, the ordering summary 130 comprises, for each beverage item requested in the plurality of orders 508, at least the item number 204, the item name 202, the item description 206, the sum of requested item quantities 302, and the retail price 210, according to various embodiments.

While it is up to the agent 126 to place orders with the distributor 146, various embodiments of the system 100 are configured to assist the agent 126 with this task, without running afoul of the law. Various embodiments of the system 100 implement a workflow to assist the agent 126 in placing the order with the distributor. Exemplary tasks include, but are not limited to, streamlining communication with the first individual 122a (e.g. acknowledging the order has been made with the distributor, etc.), downloading copies of orders, tracking orders that need to be placed, preparing the associated information in a format specific for a particular distributor, and the like. While the agent 126 still needs to be the one making the order with the distributor, the server 102 will do as much of the process as it can without usurping this responsibility from the agent 126 and violating the law.

In some embodiments, the generation of the ordering summary 130 takes the form of the generation of a document 510 that is subsequently sent to the agent 126 for conveyance to the distributor 146. See circle ‘5’. In other embodiments, the generation of the ordering summary 130 comprises the generation and transmission of an email 512 from the server 102, in response to the receipt of an instruction 514 from an agent 126 via an agent client device 124. See circle ‘6’. The inclusion of the required instruction 514 from the agent 126 before the email is transmitted prevents this method from violating the three-tier system (e.g. an automated transmission of the email may make this system the equivalent of an electronic portal for direct distributer-to-consumer sale, which is prohibited by the terms of the distributer liquor license 144 under the three-tier system.)

Once an order has been placed with the distributor 142 by the agent 126 of the entity 150, the server 102 may periodically determine and report the status of the order, in some embodiments. For example, in one embodiment, the server 102 may automatically determine the status of the purchase order by polling a third-party server 114 that is associated with the party responsible for delivering item 152 for that particular distributor 142. In another embodiment, the server 102 may poll the distributor server 110 to determine the status of the purchasing order. In other embodiments, the status of the purchasing order may be updated manually by an agent 126 (e.g. clicking a ‘order received’ button on an ordering summary interface rendered by the server 102 on the agent client device 124, etc.).

In response to the determination that the purchasing order has been received, the server 102 notifies each individual in the plurality of individuals 122 that placed an order and are receiving items 152 from this particular deliver from a specific distributor 142. See circle ‘7’. First, the server 102 retrieves, for each individual of the plurality of individuals, contact information 272 for the individual stored in the database 108.

Next, each individual is sent a notification 516 using the contact information 272. In some embodiments, the notifications 516 are sent out automatically by the server 102. In other embodiments, the notifications 516 are sent out by the server 102 in response to a command issued by an agent 126.

In some embodiments, the notification 516 informs the individuals to pick up the items 152 they requested in their individual orders, according to various embodiments. In other embodiments, the notification 516 informs the individuals that the items have arrived and their delivery to their residence is imminent.

In still other embodiments, the notification 516 may provide each individual 122 with a locker number and a passcode, allowing the agent 126 to place requested items 152 for each individual 122 in separate parcel lockers on the premises of the entity 150 or other location, from which the individuals may retrieve their order at their conveniences (in some embodiments, the individuals may have 24 hours access to the lockers). Such an implementation is advantageous, as it prevents unnecessary waiting for both the agent 126 and the individuals 122, both of whom have independent schedules. As an option, the parcel lockers may be air conditioned or other wise climate controlled, to prevent damage to the alcoholic items 152 contained within.

In some embodiments, the individuals 122 may be provided with the status of their order as it is being prepared for transmission to the distributor 142 (e.g. “in process”, “sent”, etc.). The server 102 may also convey tracking information once the distributor 142 has fulfilled the order.

The system 100 may also facilitate the delivery of the order to the individuals 122. For example, in one embodiment, the agent 126 may use the server 102 to delegate the delivery of the order to an authorized employee of the entity. In another embodiment, the server 102 may interface with another entity system, such as a member services system, to see when each individual 122 is next expected to visit the entity 150 (e.g. scheduled services, tee times, etc.) and present that as an option for delivery to the agent 126.

Eventually, each individual 122 will have to pay the entity 150 for the items they have ordered and received. According to various embodiments, the system 100 assists the entity 150 and the agents 126 of the entity 150 in invoicing the individuals 122 for their purchases. In some embodiments, the charge for the items 152 may be folded into an existing method of charging the individuals 122 for services rendered by the entity 150 (e.g. periodic billing for club services, etc.). The system 100 assist with this by generating, for each individual of the plurality of individuals 122, a periodic summary 400 identifying the beverage items 152 received for the individual by the entity 150 from the distributor 142 within a fixed period of time. See circle ‘8’. The use of periodic summaries 400 is advantageous as it allows the system 100 to assist the entity 150 with ever having to handle product or money. By keeping the hands of the system operator clean, the tiered environment 136 is not violated.

In some embodiments, the periodic summaries 400 may be generated automatically after a predefined period of time has elapsed (e.g. every month, etc.). As an option, the period may be chosen to align with the period of a method of charging individuals 122 for other goods and services rendered by the entity 150. After generation of the periodic summaries 400, the agent 126 may be notified. In other embodiments, particularly in cases where the entity 150 is a retailer 146 that is of a more transactional nature (e.g. store, restaurant, etc.), the periodic summaries 400 may be generated on demand, or in response to the occurrence of a triggering event (e.g. individual is picking up the items they ordered may trigger the creation of a periodic summary 400 for the time period between their previous transaction and the present transaction, etc.). As an option, the periodic summaries 400 may be automatically integrated with an accounting system or point of sale system already in use by the entity 150, according to some embodiments.

As previously mentioned, in some embodiments, the server 102 provides a catalog or listing of items 152 available for purchase from a distributor 142 through the entity 150, and said listing includes in indication of remaining inventory. Since a distributor 142 typically sells items 152 to more than a single retailer 146, the inventory remaining is likely to be inaccurate unless every retailer 146 is operating through the system 100. Additionally, the retail prices 210 for the items is subject to change. Furthermore, new items 152 are sometimes added to the catalog of a distributor 142 while other items 152 are removed.

Therefore, from time to time, the item records 200 of the database 108 will need to be updated. In some embodiments, the item records 200 may be updated manually (e.g. an agent 126 may obtain updated information and manually enter it into the item records, a representative of the distributor 142 may be given access to at least a portion of the database 108 so they can add updated information, etc.). In other embodiments, the server 102 may automatically update the inventory amount and retail prices of a second plurality 518 of item records using information 520 obtained by the dissemination server 102 directly from a distributor server 110. See circle ‘9’. Obtaining said information 520 may be done automatically, without human intervention, in some embodiments. In some embodiments, the connection between the dissemination server 102 and the distributor server 110 may be configured to provide updated information 520 in real time, changing as the distributor's own records change.

The systems 100 and methods contemplated herein can provide benefit to individual consumers as well as parties of every tier within the tiered environment 136. For example, consumers who are associated with a participating retailer 146 and are allowed access to the system 100 are granted a much larger selection of beverage items 152 than they would otherwise have.

Another benefit to individuals can be found when the system 100 is implemented with a retailer 146 that is a private club, such as country club, that has a food and beverage minimum that must be satisfied each month or year by the members. A food and beverage minimum is the minimum amount a member must spend on food and beverages at the club each time period. Even if the member doesn't actually purchase any food or beverages, they must pay that minimum every period (e.g. month, year, etc.). It is not uncommon for country club members to live in more than one location (e.g. people sometimes winter in warmer locations and/or summer in cooler climates, etc.). Yet, even if an individual is absent for 6 months every year, they must still meet those minimums. Some clubs allow the minimum to be met via purchasing beverage items 152 for off-site consumption. In such cases, the systems and methods contemplated herein may be used by individuals who want to make sure the food and beverage minimums they pay are always being used for something.

Another benefit may be found in cases where individuals live outside of a populated area but close to a country club. The systems and methods contemplated herein may allow an individual to obtain beverage items 152 from the club which is only minutes away, rather than a round trip of hours to a liquor store.

Benefits that may be enjoyed by participating retailers 146 are also numerous. It is not uncommon for distributors to send items in a shipment to a retailer that weren't actually ordered. While technically provided for no charge, these items can be a hassle for retailers 146, who must find a way to store them and market them. The systems and methods contemplated herein provide a way for a retailer 146 to move this unpredictable inventory with ease.

Another benefit example is when a retailer 146 has extra inventory that must be dealt with quickly. As a specific example, if a club orders 30 cases of wine for a wedding, but ends up only using 20 cases, the remaining 10 cases cannot be returned to the distributor 142 without violating the law. The systems 100 and methods contemplated herein would allow a retailer to move said inventory quickly by running a promotion and offering the extra product at a lower cost (e.g. lower margin for the retailer, etc.). Other benefits include facilitating paperless order collation, the promotion of exclusivity even within public clubs, facilitation of purchase delivery through use of automated notifications, parcel lockers, and the like.

Benefits provided to a distributor 142 include, but are not limited to, greater sales opportunities without violating the partitions of a tiered environment, and the ability to extend the marketing of distributor deals. As a specific example, distributors sometimes offer retailers a rainbow pack of tequila that contains a bottle of each type of tequila from a particular producer (e.g. silver, reposado, extra añejo, etc.). The rainbow pack may be offered at a retail price that is lower than the combined retail prices of each bottle. The systems 100 and methods contemplated herein would allow individuals to purchase said rainbow packs, enjoying the cost benefit otherwise restricted to just retailers while the distributor enjoys increased sales.

With respect to producers 138, the systems 100 and methods contemplated herein may facilitate interaction with consumers on a much larger scale than possible with traditional methods. Examples include events such as virtual tastings and wine dinners. Additionally, the systems 100 and methods contemplated herein allow a producer 138 to move excess inventory much quicker, or for more profit, than possible using traditional channels.

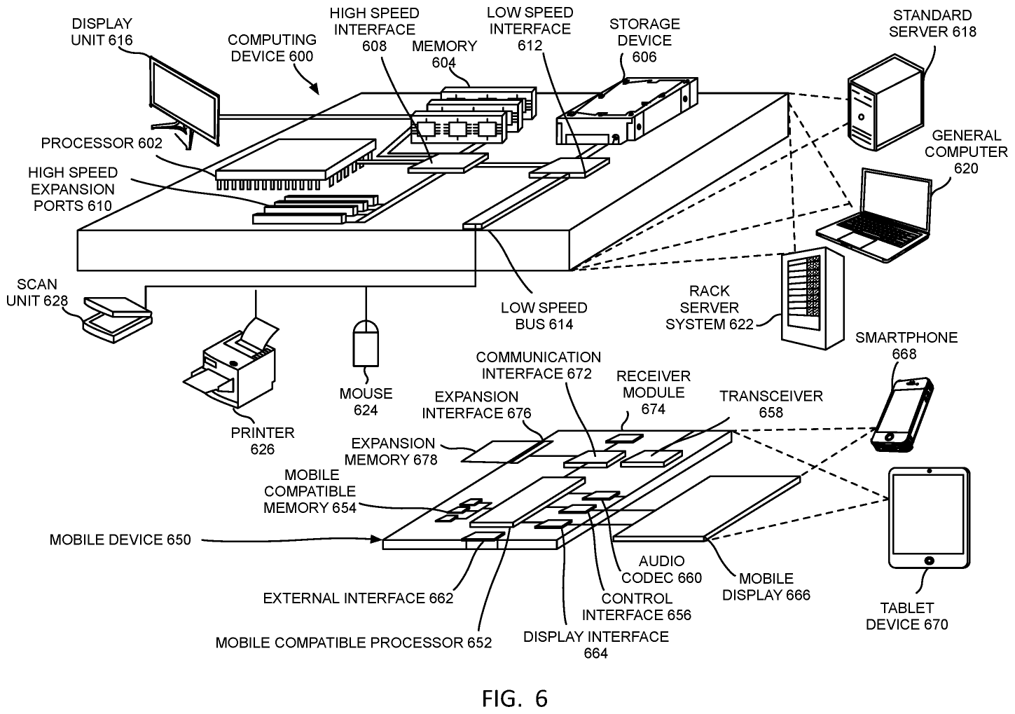

FIG. 6 is a schematic diagram of specific computing device 600 and a specific mobile computing device 650 that can be used to perform and/or implement any of the embodiments disclosed herein. In one or more embodiments, dissemination server 102, distributor server 110, producer server 112, third-party server 114, entity or retailer server 116, client devices 120, database 108, and/or agent client device 124 of FIG. 1A may be the specific computing device 600, and client devices 120 and/or agent client device 124 may also be the mobile device 650.

The specific computing device 600 may represent various forms of digital computers, such as laptops, desktops, workstations, personal digital assistants, servers, blade servers, mainframes, and/or other appropriate computers. The specific mobile computing device 650 may represent various forms of mobile devices, such as smartphones, camera phones, personal digital assistants, cellular telephones, tablets, and other similar mobile devices. The components shown here, their connections, couples, and relationships, and their functions, are meant to be exemplary only, and are not meant to limit the embodiments described and/or claimed, according to one embodiment.

The specific computing device 600 may include a processor 602, a memory 604, a storage device 606, a high speed interface 608 coupled to the memory 606 and a plurality of high speed expansion ports 610, and a low speed interface 612 coupled to a low speed bus 614 and a storage device 606. In one embodiment, each of the components heretofore may be inter-coupled using various buses, and may be mounted on a common motherboard and/or in other manners as appropriate. The processor 602 may process instructions for execution in the specific computing device 600, including instructions stored in the memory 604 and/or on the storage device 606 to display a graphical information for a GUI on an external input/output device, such as a display unit 616 coupled to the high speed interface 608, according to one embodiment.

In other embodiments, multiple processors and/or multiple buses may be used, as appropriate, along with multiple memories and/or types of memory. Also, a plurality of specific computing device 600 may be coupled with together, with each device providing portions of the necessary operations (e.g., as a server bank, a group of blade servers, and/or a multi-processor system).

The memory 604 may be coupled to the specific computing device 600. In one embodiment, the memory 604 may be a volatile memory. In another embodiment, the memory 604 may be a non-volatile memory. The memory 604 may also be another form of computer-readable medium, such as a magnetic and/or an optical disk. The storage device 606 may be capable of providing mass storage for the specific computing device 600. In one embodiment, the storage device 606 may include a floppy disk device, a hard disk device, an optical disk device, a tape device, a flash memory and/or other similar solid-state memory device. In another embodiment, the storage device 606 may be an array of the devices in a computer-readable medium previously mentioned heretofore, computer-readable medium, such as, and/or an array of devices, including devices in a storage area network and/or other configurations.

A computer program may be comprised of instructions that, when executed, perform one or more methods, such as those described above. The instructions may be stored in the memory 604, the storage device 606, a memory coupled to the processor 602, and/or a propagated signal.

The high speed interface 608 may manage bandwidth-intensive operations for the specific computing device 600, while the low speed interface 612 may manage lower bandwidth-intensive operations. Such allocation of functions is exemplary only. In one embodiment, the high speed interface 608 may be coupled to the memory 604, the display unit 616 (e.g., through a graphics processor and/or an accelerator), and to the plurality of high speed expansion ports 610, which may accept various expansion cards.

In the embodiment, the low speed interface 612 may be coupled to the storage device 606 and the low speed bus 614. The low speed bus 614 may be comprised of a wired and/or wireless communication port (e.g., a Universal Serial Bus (“USB”), a Bluetooth® port, an Ethernet port, and/or a wireless Ethernet port). The low speed bus 614 may also be coupled to the scan unit 628, a printer 626, a keyboard, a mouse 624, and a networking device (e.g., a switch and/or a router) through a network adapter.

The specific computing device 600 may be implemented in a number of different forms, as shown in the figure. In one embodiment, the specific computing device 600 may be implemented as a standard server 618 and/or a group of such servers. In another embodiment, the specific computing device 600 may be implemented as part of a rack server system 622. In yet another embodiment, the specific computing device 600 may be implemented as a general computer 620 such as a laptop or desktop computer. Alternatively, a component from the specific computing device 600 may be combined with another component in a specific mobile computing device 650. In one or more embodiments, an entire system may be made up of a plurality of specific computing device 600 and/or a plurality of specific computing device 600 coupled to a plurality of specific mobile computing device 650.

In one embodiment, the specific mobile computing device 650 may include a mobile compatible processor 652, a mobile compatible memory 654, and an input/output device such as a mobile display 666, a communication interface 672, and a transceiver 658, among other components. The specific mobile computing device 650 may also be provided with a storage device, such as a microdrive or other device, to provide additional storage. In one embodiment, the components indicated heretofore are inter-coupled using various buses, and several of the components may be mounted on a common motherboard.

The mobile compatible processor 652 may execute instructions in the specific mobile computing device 650, including instructions stored in the mobile compatible memory 654. The mobile compatible processor 652 may be implemented as a chipset of chips that include separate and multiple analog and digital processors. The mobile compatible processor 652 may provide, for example, for coordination of the other components of the specific mobile computing device 650, such as control of user interfaces, applications run by the specific mobile computing device 650, and wireless communication by the specific mobile computing device 650.

The mobile compatible processor 652 may communicate with a user through the control interface 656 and the display interface 664 coupled to a mobile display 666. In one embodiment, the mobile display 666 may be a Thin-Film-Transistor Liquid Crystal Display (“TFT LCD”), an Organic Light Emitting Diode (“OLED”) display, and another appropriate display technology. The display interface 664 may comprise appropriate circuitry for driving the mobile display 666 to present graphical and other information to a user. The control interface 656 may receive commands from a user and convert them for submission to the mobile compatible processor 652.

In addition, an external interface 662 may be provided in communication with the mobile compatible processor 652, so as to enable near area communication of the specific mobile computing device 650 with other devices. External interface 662 may provide, for example, for wired communication in some embodiments, or for wireless communication in other embodiments, and multiple interfaces may also be used.

The mobile compatible memory 654 may be coupled to the specific mobile computing device 650. The mobile compatible memory 654 may be implemented as a volatile memory and a non-volatile memory. The expansion memory 678 may also be coupled to the specific mobile computing device 650 through the expansion interface 676, which may comprise, for example, a Single In Line Memory Module (“SIMM”) card interface. The expansion memory 678 may provide extra storage space for the specific mobile computing device 650, or may also store an application or other information for the specific mobile computing device 650.

Specifically, the expansion memory 678 may comprise instructions to carry out the processes described above. The expansion memory 678 may also comprise secure information. For example, the expansion memory 678 may be provided as a security module for the specific mobile computing device 650, and may be programmed with instructions that permit secure use of the specific mobile computing device 650. In addition, a secure application may be provided on the SIMM card, along with additional information, such as placing identifying information on the SIMM card in a non-hackable manner.

The mobile compatible memory 654 may include a volatile memory (e.g., a flash memory) and a non-volatile memory (e.g., a non-volatile random-access memory (“NVRAM”)). In one embodiment, a computer program comprises a set of instructions that, when executed, perform one or more methods. The set of instructions may be stored on the mobile compatible memory 654, the expansion memory 678, a memory coupled to the mobile compatible processor 652, and a propagated signal that may be received, for example, over the transceiver 658 and/or the external interface 662.

The specific mobile computing device 650 may communicate wirelessly through the communication interface 672, which may be comprised of a digital signal processing circuitry. The communication interface 672 may provide for communications using various modes and/or protocols, such as, a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol.

Such communication may occur, for example, through the transceiver 658 (e.g., radio-frequency transceiver). In addition, short-range communication may occur, such as using a Bluetooth®, Wi-Fi, and/or other such transceiver. In addition, a GPS (“Global Positioning System”) receiver module 674 may provide additional navigation-related and location-related wireless data to the specific mobile computing device 650, which may be used as appropriate by a software application running on the specific mobile computing device 650.

The specific mobile computing device 650 may also communicate audibly using an audio codec 660, which may receive spoken information from a user and convert it to usable digital information. The audio codec 660 may likewise generate audible sound for a user, such as through a speaker (e.g., in a handset smartphone of the specific mobile computing device 650). Such a sound may comprise a sound from a voice telephone call, a recorded sound (e.g., a voice message, a music file, etc.) and may also include a sound generated by an application operating on the specific mobile computing device 650.

The specific mobile computing device 650 may be implemented in a number of different forms, as shown in the figure. In one embodiment, the specific mobile computing device 650 may be implemented as a smartphone 668. In another embodiment, the specific mobile computing device 650 may be implemented as a personal digital assistant (“PDA”). In yet another embodiment, the specific mobile computing device, 630 650 may be implemented as a tablet device 670.

Various embodiments of the systems and techniques described here can be realized in a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including one programmable processor, which may be special or general purpose, coupled to receive data and instructions from, and to transmit data and instructions to, a storage system, one input device, and at least one output device.

These computer programs (also known as programs, software, software applications, and/or code) comprise machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”), liquid crystal (“LCD”), and/or light emitting diode (“LED”) monitor) for displaying information to the user and a keyboard and a mouse by which the user can provide input to the computer. Other kinds of devices can be used to provide for interaction with a user as well; for example, feedback provided to the user can be any form of sensory feedback (e.g., visual feedback, auditory feedback, and/or tactile feedback) and input from the user can be received in any form, including acoustic, speech, and/or tactile input.

The systems and techniques described here may be implemented in a computing system that includes a back end component (e.g., as a data server), a middleware component (e.g., an application server), a front end component (e.g., a client computer having a graphical user interface, and/or a Web browser through which a user can interact with an embodiment of the systems and techniques described here), and a combination thereof. The components of the system may also be coupled through a communication network.

The communication network may include a local area network (“LAN”) and a wide area network (“WAN”) (e.g., the Internet). The computing system can include a client and a server. In one embodiment, the client and the server are remote from each other and interact through the communication network.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

It will be understood that implementations are not limited to the specific components disclosed herein, as virtually any components consistent with the intended operation of a system, method, and/or device implementation for vitality verification using a biometric one-time passcode may be utilized. Accordingly, for example, although particular systems, methods, and/or devices for biometric scans, vitality determination, and one-time passcode generation may be disclosed, such components may comprise any shape, size, style, type, model, version, class, grade, measurement, concentration, material, weight, quantity, and/or the like consistent with the intended operation of a system, method, and/or device implementation for vitality verification using a biometric one-time passcode may be used. In places where the description above refers to particular implementations of a system, method, and/or device implementation for vitality verification using a biometric one-time passcode s, it should be readily apparent that a number of modifications may be made without departing from the spirit thereof and that these implementations may be applied to other one-time passcodes and/or systems for vitality verification.

It will be understood that implementations are not limited to the specific components disclosed herein, as virtually any components consistent with the intended operation of a method and/or system for facilitating communication within a tiered environment may be utilized. Accordingly, for example, although particular systems, servers, and other hardware may be disclosed, such components may comprise any shape, size, style, type, model, version, class, grade, measurement, concentration, material, weight, quantity, and/or the like consistent with the intended operation of a method and/or system for facilitating communication within a tiered environment may be used. In places where the description above refers to particular implementations of systems and methods for facilitating communication within a tiered environment, it should be readily apparent that a number of modifications may be made without departing from the spirit thereof and that these implementations may be applied to other systems and methods for facilitating communication among regulated parties.

What is claimed is:

1. A system for facilitating communication within a tiered environment, comprising:
a database comprising a first plurality of item records, each item record describing a different beverage item provided by a distributor having a distributor liquor license within the tiered environment permitting the sale of alcohol to retailers, each item record comprising at least an item name, an item number, an inventory amount, and a retail price, the database further comprising a plurality of individual records, each associated with a different individual and comprising a contact information, as well as a plurality of retailer records each associated with a different retailer;
a dissemination server comprising a processor and a memory, the dissemination server communicatively coupled through a network to the database, a distributor server associated with the distributor, and a plurality of client devices associated with a plurality of individuals personally unlicensed within the tiered environment, the plurality of client devices comprising a first client device associated with a first individual, and an agent client device associated with an agent of an entity who is a retailer within the tiered environment having a retailer liquor license permitting the sale of alcohol to individuals, the processor of the dissemination server configured to:
receive from the first client device, over the network, credentials belonging to the first individual, for authentication, the credentials having been endorsed by the entity;
authenticate, using the processor, the credentials of the first individual;
provide to the first client device a listing of beverage items generated using at least a subset of the first plurality of item records elected by the agent of the entity, the listing of beverage items comprising, for each item elected by the agent, at least the item name and a consumer price generated by applying a markup to the retail price, the markup being stored in a retailer record specific to the entity, within the database;
receive an order from the first client device requesting at least one beverage item;
consolidate, in response to a request from the agent client device, a plurality of orders received by the dissemination server from the plurality of client devices by determining a sum of requested item quantities for each beverage item requested in the plurality of orders, each order requesting at least one beverage item;
generate an ordering summary comprising, for each beverage item requested in the plurality of orders, the item number, the item name, the item description, the sum of requested item quantities, and the retail price;
send the ordering summary to the distributor server over the network, on behalf of the entity and in response to an instruction received from the agent via the agent client device;
retrieve from the database, for each individual of the plurality of individuals, the contact information for the individual; and
notify each individual of the plurality of individuals, using the contact information retrieved from the database, to pick up the at least one beverage item requested in their order, upon determination that the at least one beverage item has arrived from the distributor.

2. The system of claim 1, wherein the processor of the dissemination server is further configured to update the inventory amount and the retail price of each item record of a second plurality of item records in the database, the second plurality of item records being at least a subset of the first plurality of item records.

3. The system of claim 2, wherein the processor of the dissemination server is configured to automatically update the inventory amount and the retail price of each item record of the second plurality of item records using information obtained by the dissemination server directly from the distributor server.

4. The system of claim 1, wherein the generation of the ordering summary comprises the generation of a document for the agent to convey to the distributor.

5. The system of claim 1, wherein the generation and sending of the ordering summary comprises the generation and transmission of an email from the dissemination server to the distributor.

6. The system of claim 1, wherein the processor of the dissemination server is further configured to retrieve at least one branding media associated with the entity from the database, and wherein the listing of beverage items is provided to the first client device concurrently with the at least one branding media associated with the entity.

7. The system of claim 1, wherein the listing of beverage items is provided to the first client device through integration with a website managed by the entity, the listing of beverage items being accessible to the first client device via the website served from an entity server communicatively coupled to the dissemination server through the network.

8. The system of claim 1:
wherein the database further comprises least one event record, each event record describing an event sponsored by at least one of the distributor and a producer having a producer liquor license within the tiered environment permitting the sale of alcohol to distributors, each event record comprising at least an event name, an event date, a number of remaining seats, and reference to at least one related beverage item records for at least one related beverage item available from the at least one of the distributor and the producer as part of the event; and
wherein the processor of the dissemination server is further configured to provide to the first client device a listing of events generated using at least a subset of the at least one event records, as elected by the agent of the entity, the listing of events comprising, for each event elected by the agent, at least the event name, the event date, the number of remaining seats, and the item name of the at least one related beverage item.

9. The system of claim 1, the processor of the dissemination server further configured to generate, for each individual of the plurality of individuals, a periodic summary identifying the beverage items received for the individual by the entity from the distributor within a fixed period of time, and at least a total amount due to the entity, the total amount due comprising a sum of the consumer price of each beverage items received for the individual, as determined when the beverage item was requested by the individual.

10. The system of claim 1, wherein the determination that the at least one beverage item has arrived from the distributor is made automatically by the dissemination server through communication with at least one of the distributor server and a third-party server.

11. A method for facilitating communication within a tiered environment, comprising:
storing in a database communicatively coupled to a dissemination server a first plurality of item records, each item record describing a different beverage item provided by a distributor within the tiered environment, each item record comprising at least an item name, an item number, an inventory amount, and a retail price;
receiving at the dissemination server, over a network, credentials from a first individual for authentication, the first individual unlicensed within the tiered environment, the credentials having been endorsed by an entity with whom the individual is affiliated, the entity being a retailer within the tiered environment and having a retailer liquor license permitting the sale of alcohol to individuals;
authenticating, using a processor and a memory of the dissemination server, the credentials of the first individual;
providing to a first client device associated with the first individual a listing of beverage items generated using at least a subset of the first plurality of item records elected by an agent of the entity, the listing of beverage items comprising, for each item elected by the agent, at least the item name and a consumer price generated by applying a markup to the retail price, the markup being stored in a retailer record specific to the entity, within the database;
receiving an order from the first individual requesting at least one beverage item;
consolidating, in response to a request from the agent of the entity, a plurality of orders from a plurality of authenticated individuals by determining a sum of requested item quantities for each beverage item requested in the plurality of orders, each order requesting at least one beverage item;
generating an ordering summary comprising, for each beverage item requested in the plurality of orders, the item number, the item name, the item description, the sum of requested item quantities, and the retail price;
sending the ordering summary to the distributor, on behalf of the entity and in response to an instruction received from the agent;
retrieving, for each individual of the plurality of individuals, a contact information for the individual, the contact information being stored in an individual record in the database; and
notifying each individual of the plurality of individuals to pick up the at least one beverage item requested in their order, upon determination that the at least one beverage item has arrived from the distributor, the notification performed using the contact information retrieved from the database.

12. The method of claim 11, further comprising updating the inventory amount and the retail price of each item record of a second plurality of item records in the database, the second plurality of item records being at least a subset of the first plurality of item records.

13. The method of claim 12, wherein updating the inventory amount and the retail price of each item record of the second plurality of item records is done automatically, using information obtained by the dissemination server directly from a distributor server.

14. The method of claim 11, wherein the generation of the ordering summary comprises the generation of a document for the agent to convey to the distributor.

15. The method of claim 11, wherein the generation and sending of the ordering summary comprises the generation and transmission of an email from the dissemination server to the distributor.

16. The method of claim 11, further comprising:
retrieving at least one branding media associated with the entity from the database;
wherein the listing of beverage items is provided to the first client device along with the at least one branding media associated with the entity.

17. The method of claim 11, wherein the listing of beverage items is provided to the first client device through integration with a website managed by the entity, the listing of beverage items being accessible via the web site served from an entity server communicatively coupled to the dissemination server through the network.

18. The method of claim 11, further comprising:
storing in the database at least one event record, each event record describing an event sponsored by at least one of the distributor and a producer having a producer liquor license within the tiered environment permitting the sale of alcohol to distributors, each event record comprising at least an event name, an event date, a number of remaining seats, and reference to at least one related beverage item records for at least one related beverage item available from the at least one of the distributor and the producer as part of the event; and
providing to the first individual a listing of events generated using at least a subset of the at least one event records, as elected by the agent of the entity, the listing of events comprising, for each event elected by the agent, at least the event name, the event date, the number of remaining seats, and the item name of the at least one related beverage item.

19. The method of claim 11, further comprising generating, for each individual of the plurality of individuals, a periodic summary identifying the beverage items received for the individual by the entity from the distributor within a fixed period of time, and at least a total amount due to the entity, the total amount due comprising a sum of the consumer price of each beverage items received for the individual, as determined when the beverage item was requested by the individual.

20. The method of claim 11, wherein the determination that the at least one beverage item has arrived from the distributor is made automatically by the dissemination server through communication with at least one of a distributor server and a third-party server.
